(19) United States
(12) Patent Application Publication
(10) Pub. No.: US 2021/0334615 A1
(43) Pub. Date: Oct. 28, 2021

(54) SMART CARD

(71) Applicant: Infineon Technologies AG, Neubiberg (DE)

(72) Inventor: Walter Kargl, Graz (AT)

(21) Appl. No.: 17/241,605

(22) Filed: Apr. 27, 2021

(30) Foreign Application Priority Data
Apr. 28, 2020 (DE) 102020111565.2

(51) Int. Cl. G06K 19/07; G06K 19/077

(52) U.S. Cl. CPC G06K 19/0718; G06K 19/07794; G06K 19/07779; G06K 19/0723; G06K 19/07735; G06K 19/07747; G06K 19/0709

(57) ABSTRACT

A smartcard having a security controller, a fingerprint sensor, and an energy supply circuit configured to supply the security controller and the fingerprint sensor with energy, wherein the security controller and the fingerprint sensor are configured to communicate with one another by means of inductive coupling.

### TECHNICAL FIELD

The disclosure relates to a smartcard, in particular a smartcard having a fingerprint sensor.

### BACKGROUND

Current biometric smartcards typically comprise a communication module configured for communication with an external reader, and a fingerprint module. The communication module can be configured as a dual interface module. The two components are typically based on printed circuit boards (PCBs) and are directly electrically connected to one another by lines within the card.

That means that both in the case of contact-based operation of the card and in the case of contactless operation of the card, supply of energy to the fingerprint module and exchange of information between the dual interface module and the fingerprint module are effected by means of the lines that are directly electrically connected to both modules.

The integration and the connection of the modules to the lines are expensive and susceptible to faults, which can adversely affect the yield during production.

### SUMMARY

In various exemplary aspects, a smartcard having a fingerprint module without direct electrical connections is provided. Supply of energy to the fingerprint module can be effected by means of inductive coupling. Furthermore, communication between a communication module of the smartcard and the fingerprint module can be effected by means of inductive coupling.

In various exemplary aspects, the smartcard can be formed as a contact-based smartcard, for example having standard contact pads in accordance with ISO 7816, as a contactless smartcard, or as a dual interface smartcard enabling both contact-based operation and contactless operation.

In various exemplary aspects, both the fingerprint module and the communication module can comprise an antenna. A booster antenna can be provided in the smartcard body, which booster antenna can comprise a first coupling zone and a second coupling zone. The first coupling zone can be configured to couple inductively to the antenna of the communication module, and the second coupling zone can be configured to couple inductively to the antenna of the fingerprint module.

Described illustratively, in various exemplary aspects, the communication module can be configured as a contactless reader for the fingerprint sensor.

The explanations herein refer to a fingerprint module or a fingerprint sensor. In various exemplary aspects, some other type of biometric sensor suitable for use in a smartcard can be used instead of the fingerprint sensor.

### BRIEF DESCRIPTION OF THE DRAWINGS

Exemplary aspects of the disclosure are illustrated in the figures and are explained in greater detail below.

In the figures:

FIG. 1A shows a schematic plan view of a smartcard in accordance with various exemplary aspects;

FIG. 1B shows the schematic plan view of the smartcard from FIG. 1A with an illustration of energy and information flows;

FIG. 1C shows a schematic plan view of a smartcard in accordance with various exemplary aspects with an illustration of energy and information flows;

FIGS. 2A and 2B each show a cross-sectional view of a smartcard in accordance with various exemplary aspects;

FIG. 3A shows a schematic plan view of a smartcard in accordance with various exemplary aspects;

FIG. 3B shows the schematic plan view of the smartcard from FIG. 3A with an illustration of energy and information flows;

FIGS. 4A and 4B each show a cross-sectional view of a smartcard in accordance with various exemplary aspects;

FIG. 5 shows a flow diagram of a method for operating a smartcard in accordance with various exemplary aspects; and

FIG. 6 shows a flow diagram of a method for operating a smartcard in accordance with various exemplary aspects.

### DETAILED DESCRIPTION

In the following detailed description, reference is made to the accompanying drawings, which form part of this description and show for illustration purposes specific aspects in which subject matter of the disclosure can be implemented. In this regard, direction terminology such as, for instance, “at the top”, “at the bottom”, “at the front”, “at the back”, “front”, “rear”, etc. is used with respect to the orientation of the figure(s) described. Since components of aspects can be positioned in a number of different orientations, the direction terminology serves for illustration and is not restrictive in any way whatsoever. It goes without saying that other aspects can be used and structural or logical changes can be made, without departing from the scope of protection of the present disclosure. It goes without saying that the features of the various exemplary aspects described herein can be combined with one another, unless specifically indicated otherwise. Therefore, the following detailed description should not be interpreted in a restrictive sense, and the scope of protection of the present disclosure is defined by the appended claims.

In the context of this description, the terms “connected”, “attached” and “coupled” are used to describe both a direct and an indirect connection, a direct or indirect attachment and a direct or indirect coupling. In the figures, identical or similar elements are provided with identical reference signs, insofar as this is expedient.

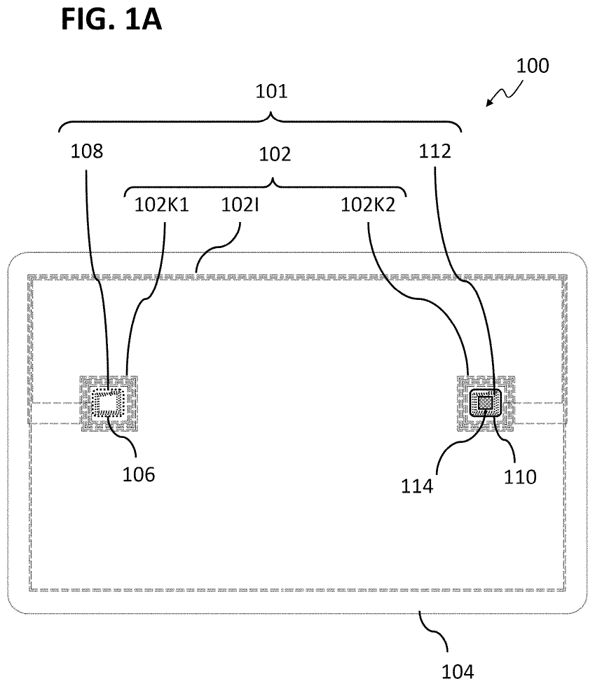

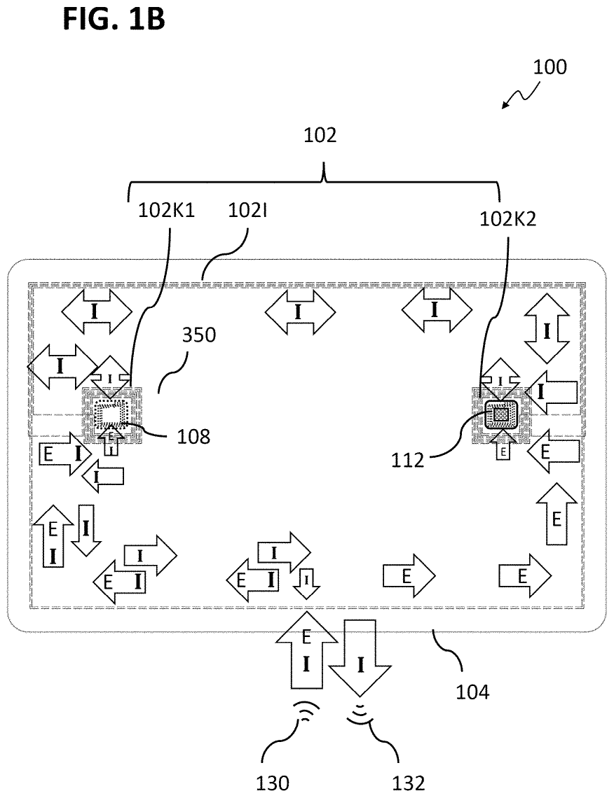

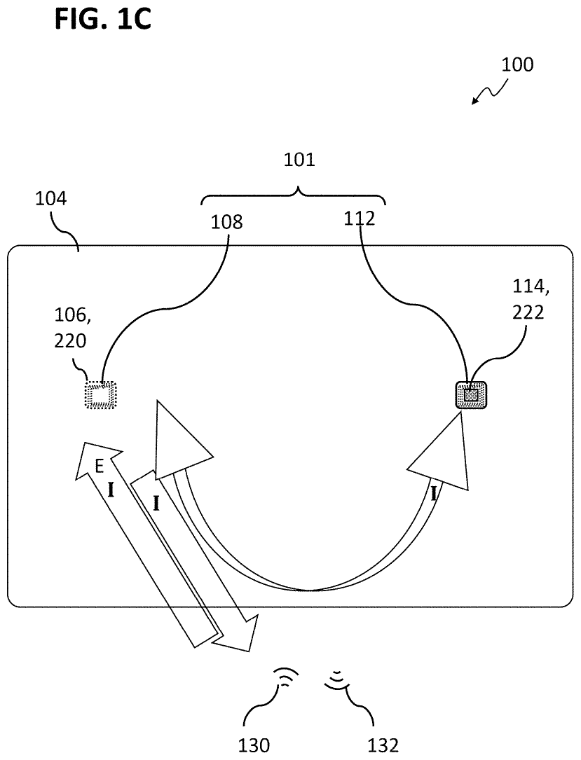

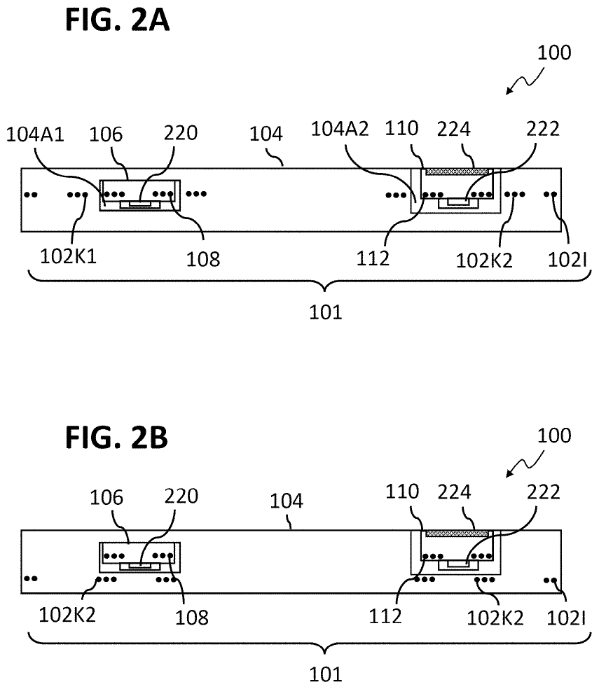

FIG. 1A shows a schematic plan view of a smartcard 100 in accordance with various exemplary aspects, FIG. 1B shows the schematic plan view of the smartcard 100 from FIG. 1A with an illustration of energy and information flows, and FIGS. 2A and 2B each show a cross-sectional view of a smartcard 100 in accordance with various exemplary aspects, wherein FIG. 2A can be for example a cross-sectional view of the smartcard 100 from FIG. 1A.

The smartcard 100 can comprise a security controller 220, a fingerprint sensor 224 and an energy supply circuit 101 for supplying the security controller 220 and the fingerprint sensor 224 with energy, wherein the security controller 220 and the fingerprint sensor 224 can be configured for communication with one another by means of inductive coupling.

The security controller 220 can also be referred to as a secure element and can be similar to security controllers which are used in smartcards in accordance with the prior art. The security controller 220 can be configured to enable data to be exchanged with an external reader in a manner protected against unauthorized access and/or manipulation, that is, securely. The external reader is not illustrated in the figures, although FIG. 1B illustrates the data/energy 130 received from the reader wirelessly in the smartcard 100 and the data 132 transmitted to the reader wirelessly by the smartcard 100.

In addition to information I, energy E is provided with the received data 130. The smartcard 100 can be configured to use the energy provided by the reader for operating the security controller 220.

In various exemplary aspects, the security controller 220 can be part of a chip module 106. In various exemplary aspects, the chip module 106—and thus the smartcard 100—can be configured for a contactless use. In various exemplary aspects, the chip module 106—and thus the smartcard 100—can furthermore be configured for a contact-based use.

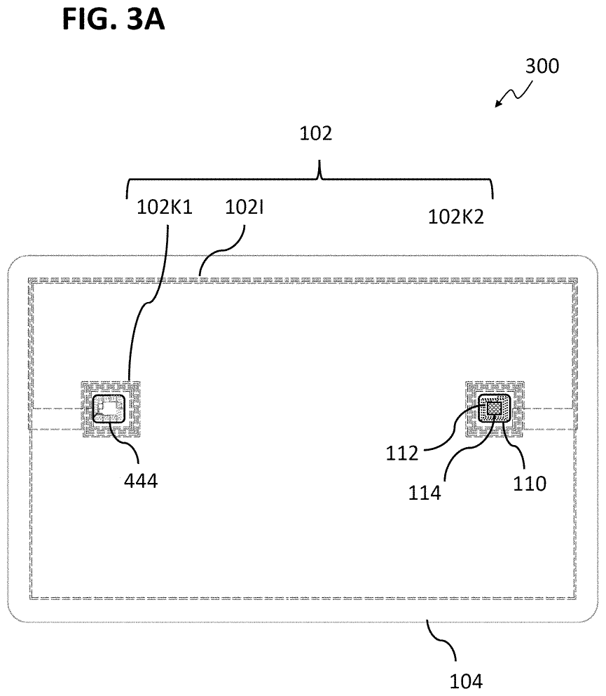

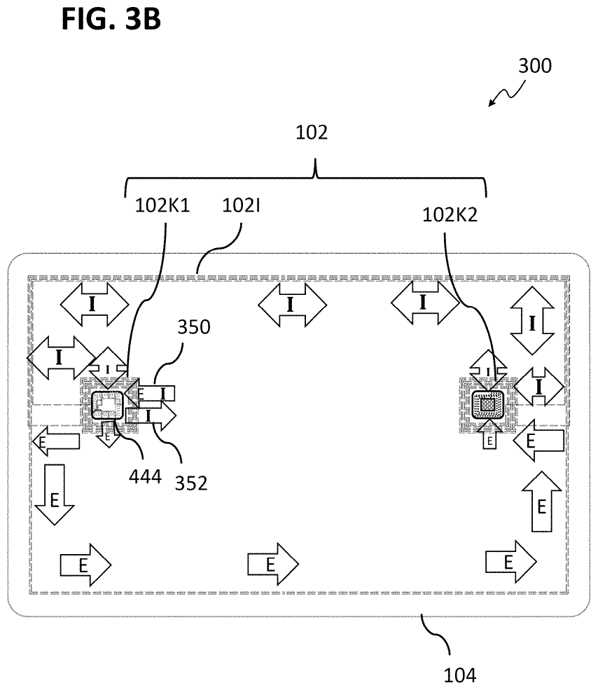

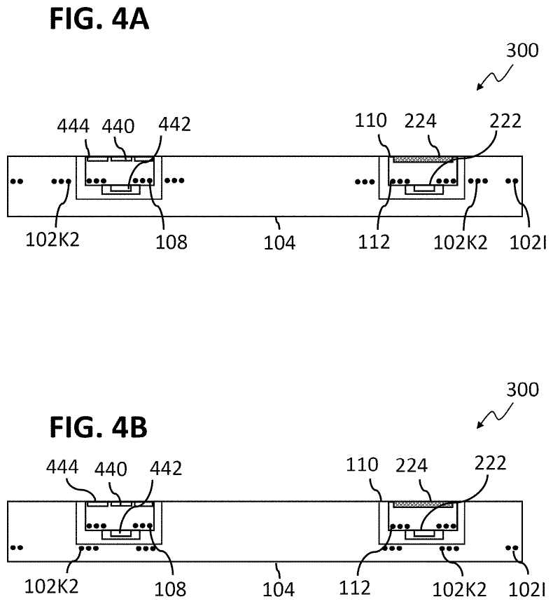

In various exemplary aspects, in the case of an additional contact-based use, the chip module 106 can furthermore comprise exposed contact pads, which can be formed in accordance with ISO 7816, for example. The contact pads are not illustrated in FIGS. 2A and 2B, but can be formed for example like the contact pads 440 in FIGS. 4A and FIG. 4B of the smartcard 300, for example in a manner substantially as known from the prior art. In the case of the contact-based use, the chip module can furthermore have properties that are described for contact-based operation in association with FIGS. 3A, 3B, 4A and 4B.

The security controller 220 can be electrically conductively connected to a first antenna 108 for providing the inductive coupling. The first antenna 108 can be part of the energy supply circuit 101. The chip module 106 can be provided as a so-called “Coil-on-Module” (CoM) chip module 106, for example, in which the security controller 220 and the antenna 108 electrically conductively connected thereto are integrated in the chip module 106.

The fingerprint sensor 224 can comprise any desired type of fingerprint sensor that can be employed in a smartcard 100, for example a silicon-based fingerprint sensor or a fingerprint sensor having a printed circuit board and a plurality of sensor elements.

In various exemplary aspects, the fingerprint sensor 224 can be electrically conductively connected to a second antenna 112 for providing the inductive coupling. The second antenna 112 can be part of the energy supply circuit 101.

The fingerprint sensor 224 can be part of a sensor module 110, for example, which, in various exemplary aspects, can be formed as a Coil-on-Module sensor module 110 comprising both the fingerprint sensor 224 and the second antenna 112.

The fingerprint sensor 224 can furthermore comprise a sensor chip 222. The sensor chip 222 can be electrically conductively connected to the sensor area and to the second antenna 112. The sensor chip 222 can be configured, for example, as is known in the prior art, to evaluate the measured values detected by the sensor area and to provide them as fingerprint data for a comparison.

The fingerprint sensor 224 can be configured to obtain its operating energy by means of inductive coupling. By way of example, energy received by means of inductive coupling in the second antenna 112 can be used to operate the sensor area and the sensor chip 222.

In various exemplary aspects, the energy supply circuit 101 can comprise a booster antenna 102 having two coupling zones 102K1, 102K2. The booster antenna 102 can be configured, in a manner substantially as known in the prior art, to communicate with the external reader, that is, it can have a corresponding material, geometric configuration, frequency tuning (e.g. to the customary 13.56 MHz), etc., in order to couple inductively to the external reader, for example by means of an external coupling region 1021.

The two coupling zones 102K1, 102K2 can comprise a first coupling zone 102K1 for coupling to the first antenna 108 connected to the security controller 220, and a second coupling zone 102K2 for coupling to the second antenna 112 connected to the security controller 220.

FIG. 1B illustrates how the booster antenna 102 couples to the external reader, the first antenna 108 and the second antenna 112 in order to provide energy E to the security controller 220 and the fingerprint sensor 224, which can be arranged in a manner spaced apart from one another in the smartcard 100, and in order to enable communication (with transfer of data or information I) between the security controller 220 and the fingerprint sensor 224. For the sake of clarity, the figure depicts some of the symbols along an upper region of the booster antenna 102, and some of the symbols along a lower region 102, which is technically unimportant since both regions are part of the same booster antenna 102.

The booster antenna 102, by way of its external coupling region 102I, can couple inductively to the external reader in order to receive energy E and data I as an incoming signal 130 and/or to transmit data I as an outgoing signal 132.

The energy E (or a portion thereof) received by the booster antenna 102 can be transferred to the first antenna 108 inductively by means of the first coupling zone 102K1. For this purpose, the first coupling zone 102K1 can be arranged spatially adjacent to the first antenna 108, for example around a chip module accommodating region 104A1, in which the chip module 106 having the security controller 220 is arranged, as illustrated in FIG. 2A, or below the chip module accommodating region 104A1, as in FIG. 2B. The transfer of energy E and data I between the coupling region 102K1 and the first antenna 108 can be effected in a manner that is substantially known for CoM chip modules.

The energy E (or a portion thereof) received by the booster antenna 102 can be transferred to the second antenna 112 inductively by means of the second coupling zone 102K2. For this purpose, the second coupling zone 102K2 can be arranged spatially adjacent to the second antenna 112, for example around a sensor module accommodating region 104A2, in which the sensor module 110 having the fingerprint sensor 224 is arranged, as illustrated in FIG. 2A, or below the sensor module accommodating region 104A2, as in FIG. 2B.

Communication, that is, transfer of data I, between the security controller 220 and the fingerprint sensor 224 can be effected from the security controller 220 via the first antenna 108, the external coupling region 102I, the second coupling zone and the second antenna 112, for example by means of a load modulation.

The security controller 220 can be configured to effect the load modulation at the signal 130 received from the external reader and to process a corresponding load modulation effected by the sensor chip 222, in order to extract information.

Conversely, the sensor chip 222 can be configured to effect the load modulation at the signal 130 received from the external reader and to process a corresponding load modulation effected by the security controller 220, in order to extract information.

The communication can be effected for example as in the case of a FeliCa communication interface. Bit coding and data coding of this technology are symmetrical for the transmission and reception of data.

FIG. 1C shows a schematic plan view of a smartcard 100 in accordance with various exemplary aspects with an illustration of energy and information flows. Various elements and functions of the smartcard 100 from FIG. 1C can be similar or identical to the smartcard 100 from FIG. 1A and/or 1B. Differences are explained below.

In various exemplary aspects, the energy supply circuit 101 can be configured without the booster antenna 102.

In such a case, the chip module 106 can be configured, by way of its first antenna 108, to couple inductively directly to an external reader for the purpose of wirelessly receiving data I and/or energy E (provided by the external reader as signal 130) and for the purpose of transmitting data 132 to the external reader.

The smartcard 100 can be configured to use the energy E provided by the reader for operating the security controller 220.

Furthermore, the sensor module 110 can be configured, by way of its second antenna 112, to couple inductively directly to the external reader for the purpose of wirelessly receiving energy E.

Communication between the chip module 106 and the sensor module 110 can be effected for example indirectly by means of load modulation of the signal provided by the external reader, which is illustrated with the aid of the curved arrow in FIG. 1C.

In various exemplary aspects, the sensor module 110 can furthermore comprise a second chip (not illustrated). In various exemplary aspects, the second chip can be electrically conductively connected to the second antenna 112. The fingerprint sensor 114 can be connected to the second antenna 112 indirectly by means of the second chip.

To put it another way, the second chip, which can be formed as a security controller, for example, can be electrically conductively connected to the energy supply circuit 101 and the fingerprint sensor.

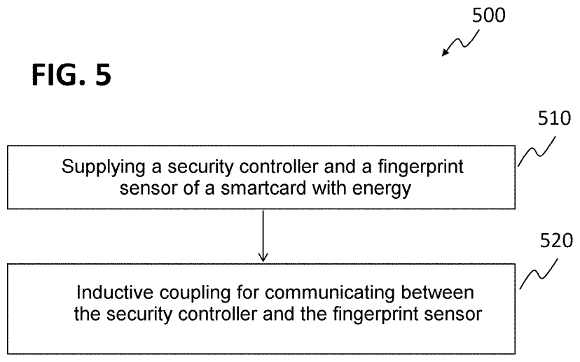

FIG. 5 shows a flow diagram 500 of a method in accordance with various exemplary aspects for operating a smartcard comprising a security controller and a fingerprint sensor. The method comprises supplying the security controller and the fingerprint sensor with energy (510) and inductive coupling for communicating between the security controller and the fingerprint sensor (520).

FIG. 3A shows a schematic plan view of a smartcard 300 in accordance with various exemplary aspects, FIG. 3B shows the schematic plan view of the smartcard from FIG. 3A with an illustration of energy and information flows, and FIG. 4A and FIG. 4B each show a cross-sectional view of a smartcard 300 in accordance with various exemplary aspects, wherein FIG. 4A can be for example a cross-sectional view of the smartcard 300 from FIG. 3A.

The smartcard 300 can comprise a first Coil-on-Module (COM) component 444 having an antenna 108 and an energy supply circuit 442, and a second COM component 110 having an antenna 112 and a fingerprint sensor 224. The energy supply circuit 442 of the first COM component 444 can be configured for providing electrical energy E to the fingerprint sensor 224. In this case, the energy E can be provided by means of inductive coupling between the antenna 108 of the first COM component 444 and the antenna 112 of the second COM component 110.

In various exemplary aspects, the smartcard 300 can comprise a booster antenna 102, which can comprise a first coupling zone 102K1 for inductive coupling to the antenna of the first COM component 444 and a second coupling zone 102K2 for inductive coupling to the antenna 112 of the second COM component 110.

The booster antenna 102 can be formed substantially or completely like the booster antenna 102 described above, for example in association with FIGS. 1A to 2B. A repetition is therefore dispensed with here.

Likewise, the second COM component 110 can be formed substantially or completely like the sensor module 110 described above, for example in association with FIGS. 1A to 2B. A repetition is therefore dispensed with here.

In various exemplary aspects, the first Coil-on-Module (COM) component 444 can be configured for a contact-based use. The first Coil-on-Module (COM) component 444 can comprise exposed contact pads 440 of a contact-based interface for contact-based communication, which contact pads can be formed for example in accordance with ISO 7816, for example in a manner substantially as known from the prior art.

The contact-based interface (e.g. the contact pads 440) can be electrically conductively connected to the energy supply circuit 442 and be configured to supply the first Coil-on-Module component 444 with energy.

The energy supply circuit 442 can comprise a security controller, which, by means of the contact-based interface, for example from an external reader, can be supplied with energy E and receive information I, which is illustrated as input signal 350 into the first COM component 444 in FIG. 3B. By means of the contact-based interface, the security controller can provide to the external reader information I, which is illustrated as output signal 352.

The security controller can be configured to operate the antenna 108 as a transmitting and/or receiving antenna for the purpose of providing the energy E and information I by means of inductive coupling to the second COM component 110 or the fingerprint sensor 224 contained therein.

Described illustratively, in various exemplary aspects, the first COM component 444 can be configured as a contactless reader for the fingerprint sensor 224 in the second COM component 110. The energy supply circuit 442 can comprise for example a reader module, for example as part of the security controller or electrically conductively connected thereto.

The energy supply circuit 442 (e.g. the security controller) can be configured to activate the reader module in the case of a contact-based activation of the security controller. The reader module can be configured to generate a power signal, for example a 13.56 MHz driver signal, which is provided to the connected antenna 108.

The antenna 108 of the first COM component 444 can then couple to the booster antenna 102 by means of the first coupling zone 102K1, which booster antenna can amplify the signal and, by means of the second coupling zone 102K2, transfer it to the second COM component 110, for example to the antenna 112 of the second COM component 110.

Consequently, as is illustrated by way of example in FIG. 3B, energy E and information I can be transferred from the first COM component 444, which is contacted for contact-based communication by means of the contact-based interface, to the fingerprint sensor 224 of the second COM component 444, and the fingerprint sensor 224 can thus be supplied and operated with energy E.

In various exemplary aspects, a standard contactless communication protocol such as, for example, FeliCa or an optimized proprietary scheme can be used for the communication.

For transfer of information from the second COM component 110 to the first COM component, the second COM component 110 can be configured to carry out a load modulation at the signal provided by the first Coil-on-Module component 440. For this purpose, the second COM component 110 can be substantially configured as described in the context above for the sensor module 110, and so a repetition is dispensed with here.

Accordingly, a smartcard 300 can be provided which makes it possible to operate a fingerprint sensor 224 (not electrically conductively connected to the contact-based interface) in the case of contact-based operation of the smartcard 300.

Production methods which are known from the production of Coil-on-Module components and are relatively cost-effective can be used in this case.

In various exemplary aspects, the first COM component 440 can be formed as a dual interface component. In that case, for contactless operation it can furthermore have properties described above in connection with the smartcard 100.

The smartcard 100, 300 provided as a dual interface smartcard in various exemplary aspects can be configured, in the case of operation by means of the contact-based interface, to activate the transmission module in the first COM component (the chip module) 440/106 and to transfer energy E and information I by means of inductive coupling to the second COM component (the sensor module) 110, and, in the case of contactless operation by means of the booster antenna 102, to transfer energy and information both to the first COM component (the chip module) 440/106 and to the second COM component (the sensor module) 110 by means of inductive coupling, and to enable communication between the first COM component (the chip module) 440/106 and the second COM component (the sensor module) 110 by means of inductive coupling.

In various exemplary aspects, the second COM component (the sensor module) 110 can furthermore comprise a second chip (not illustrated). In various exemplary aspects, the second chip can be electrically conductively connected to the second antenna 112. The fingerprint sensor 114 can be connected to the second antenna 112 indirectly by means of the second chip.

To put it another way, the second chip, which can be formed as a security controller, for example, can be electrically conductively connected to the energy supply circuit 101 and the fingerprint sensor.

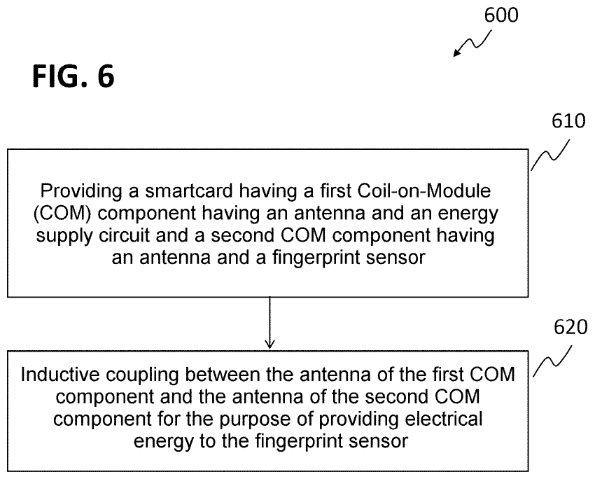

FIG. 6 shows a flow diagram 600 of a method in accordance with various exemplary aspects for operating a smartcard comprising a fingerprint sensor. The method comprises providing a first Coil-on-Module (COM) component having an antenna and an energy supply circuit and a second COM component having an antenna and the fingerprint sensor (610), and inductive coupling between the antenna of the first COM component and the antenna of the second COM component for the purpose of providing electrical energy to the fingerprint sensor (620).

Some exemplary aspects are specified in summary hereinafter.

Exemplary aspect 1 is a smartcard. The smartcard comprises a security controller, a fingerprint sensor, an energy supply circuit for supplying the security controller and the fingerprint sensor with energy, wherein the security controller and the fingerprint sensor are configured for communication with one another by means of inductive coupling.

Exemplary aspect 2 is a smartcard in accordance with exemplary aspect 1, wherein the energy supply circuit comprises a booster antenna having two coupling zones.

Exemplary aspect 3 is a smartcard in accordance with exemplary aspect 1 or 2, wherein the security controller is electrically conductively connected to a first antenna for providing the inductive coupling.

Exemplary aspect 4 is a smartcard in accordance with any of exemplary aspects 1 to 3, wherein the fingerprint sensor is electrically conductively connected to a second antenna for providing the inductive coupling.

Exemplary aspect 5 is a smartcard in accordance with any of exemplary aspects 2 to 4, wherein the inductive coupling for communication is effected by means of the booster antenna.

Exemplary aspect 6 is a smartcard in accordance with any of exemplary aspects 1 to 5, wherein the security controller and the fingerprint sensor are arranged in a manner spatially separated from one another.

Exemplary aspect 7 is a smartcard in accordance with any of exemplary aspects 1 to 6, which furthermore comprises a contact-based interface for contact-based communication, wherein the security controller is optionally part of a dual interface Coil-on-Module chip module.

Exemplary aspect 8 is a smartcard in accordance with any of exemplary aspects 1 to 7, wherein the communication between the security controller and the fingerprint sensor is effected by means of load modulation.

Exemplary aspect 9 is a smartcard in accordance with any of exemplary aspects 1 to 8, wherein the security controller is part of a Coil-on-Module chip module; and/or wherein the fingerprint sensor is configured as a Coil-on-Module device.

Exemplary aspect 10 is a smartcard in accordance with any of exemplary aspects 1 to 9, wherein the sensor device is formed as an individual integrated module.

Exemplary aspect 11 is a smartcard in accordance with any of exemplary aspects 1 to 10, wherein the energy supply circuit is configured to obtain energy inductively from an external reader.

Exemplary aspect 12 is a smartcard. The smartcard comprises a first Coil-on-Module (COM) component having an antenna and an energy supply circuit, and a second COM component having an antenna and a fingerprint sensor, wherein the energy supply circuit of the first COM component is configured for providing electrical energy by means of inductive coupling between the antenna of the first COM component and the antenna of the second COM component to the fingerprint sensor.

Exemplary aspect 13 is a smartcard in accordance with exemplary aspect 12, which furthermore comprises a booster antenna comprising a first coupling zone for inductive coupling to the antenna of the first COM component, and comprising a second coupling zone for inductive coupling to the antenna of the second COM component.

Exemplary aspect 14 is a smartcard in accordance with exemplary aspect 12 or 13, which further comprises a contact-based interface for contact-based communication, wherein the contact-based interface is electrically conductively connected to the energy supply circuit and is configured to supply the first Coil-on-Module component with energy.

Exemplary aspect 15 is a smartcard in accordance with any of exemplary aspects 12 to 14, wherein the first Coil-on-Module (COM) component and the second Coil-on-Module (COM) component are configured for communication with one another by means of inductive coupling, for example by means of load modulation.

Exemplary aspect 16 is a smartcard in accordance with any of exemplary aspects 12 to 15, wherein the first Coil-on-Module (COM) component furthermore comprises a security controller.

Exemplary aspect 17 is a smartcard in accordance with any of exemplary aspects 12 to 16, wherein the fingerprint sensor comprises a sensor area having a multiplicity of sensor pads.

Exemplary aspect 18 is a smartcard in accordance with any of exemplary aspects 12 to 17, wherein the fingerprint sensor comprises a sensor chip, configured for processing detected sensor signals.

Exemplary aspect 19 is a smartcard in accordance with any of exemplary aspects 12 to 18, wherein the antenna of the second COM component has a basic area that is less than or substantially equal to the basic area of a sensor area of the fingerprint sensor.

Exemplary aspect 20 is a smartcard in accordance with any of exemplary aspects 12 to 19, which furthermore comprises a shield arranged between the fingerprint sensor and the antenna of the second COM component.

Exemplary aspect 21 is a smartcard in accordance with exemplary aspect 20, wherein the shield comprises ferrite and/or is at grounding potential.

Exemplary aspect 22 is a method for operating a smartcard comprising a security controller and a fingerprint sensor. The method comprises supplying the security controller and the fingerprint sensor of the smartcard with energy and inductive coupling for communicating between the security controller and the fingerprint sensor.

Exemplary aspect 23 is a method for operating a smartcard comprising a security controller and a fingerprint sensor. The method comprises providing a first Coil-on-Module (COM) component having an antenna and an energy supply circuit and a second COM component having an antenna and the fingerprint sensor, and inductive coupling between the antenna of the first COM component and the antenna of the second COM component for the purpose of providing electrical energy to the fingerprint sensor.

Further advantageous configurations of the device are evident from the description of the method, and vice versa.

1. A smartcard, comprising:
a security controller;
a fingerprint sensor; and
an energy supply circuit configured to supply the security controller and the fingerprint sensor with energy,
wherein the security controller and the fingerprint sensor are configured to communicate with one another by means of inductive coupling.

2. The smartcard as claimed in claim 1,
wherein the energy supply circuit comprises a booster antenna having two coupling zones.

3. The smartcard as claimed in claim 1,
wherein the security controller is electrically conductively connected to a first antenna to provide the inductive coupling.

4. The smartcard as claimed in claim 1,
wherein the fingerprint sensor is electrically conductively connected to a second antenna to provide the inductive coupling.

5. The smartcard as claimed in claim 2,
wherein the inductive coupling for communication is effected by means of the booster antenna.

6. The smartcard as claimed in claim 1,
wherein the security controller and the fingerprint sensor are arranged in a manner spatially separated from one another.

7. The smartcard as claimed in claim 1, further comprising:
a contact-based interface for contact-based communication,
wherein the security controller is part of a dual interface Coil-on-Module chip module.

8. The smartcard as claimed in claim 1,
wherein the communication between the security controller and the fingerprint sensor is effected by means of load modulation.

9. The smartcard as claimed in claim 1,
wherein the security controller is part of a Coil-on-Module chip module, and/or
wherein the fingerprint sensor is configured as a Coil-on-Module device.

10. The smartcard as claimed in claim 1,
wherein the fingerprint sensor is formed as an individual integrated module.

11. The smartcard as claimed in claim 1,
wherein the energy supply circuit is configured to obtain energy inductively from an external reader.

12. A smartcard, comprising:
a first Coil-on-Module (COM) component having an antenna and an energy supply circuit; and
a second COM component having an antenna and a fingerprint sensor,
wherein the energy supply circuit of the first COM component is configured to provide electrical energy by means of inductive coupling between the antenna of the first COM component and the antenna of the second COM component to the fingerprint sensor.

13. The smartcard as claimed in claim 12, further comprising:
a booster antenna comprising a first coupling zone for inductive coupling to the antenna of the first COM component, and a second coupling zone for inductive coupling to the antenna of the second COM component.

14. The smartcard as claimed in claim 12, further comprising:
a contact-based interface for contact-based communication,
wherein the contact-based interface is electrically conductively connected to the energy supply circuit and is configured to supply the first Coil-on-Module component with energy.

15. The smartcard as claimed in claim 12,
wherein the first Coil-on-Module (COM) component and the second Coil-on-Module (COM) component are configured to communicate with one another by means of inductive coupling.

16. The smartcard as claimed in claim 12,
wherein the first Coil-on-Module (COM) component further comprises a security controller.

17. The smartcard as claimed in claim 12,
wherein the fingerprint sensor comprises a sensor area having a plurality of sensor pads.

18. The smartcard as claimed in claim 12,
wherein the fingerprint sensor comprises a sensor chip configured to process detected sensor signals.

19. The smartcard as claimed in claim 12,
wherein the antenna of the second COM component has an area that is less than or substantially equal to an area of the fingerprint sensor.

20. The smartcard as claimed in claim 12, further comprising:
a shield arranged between the fingerprint sensor and the antenna of the second COM component.
